(19) United States
(12) Patent Application Publication
(10) Pub. No.: US 2012/0293494 A1
(43) Pub. Date: Nov. 22, 2012

(54) COMPUTER-READABLE STORAGE MEDIUM HAVING DISPLAY CONTROL PROGRAM STORED THEREIN, DISPLAY CONTROL APPARATUS, DISPLAY CONTROL SYSTEM, AND DISPLAY CONTROL METHOD

(75) Inventors: Tomoaki KUROUME, Kyoto (JP); Tetsuya Sasaki, Kyoto (JP); Eiichi Shirakawa, Kyoto (JP)

(73) Assignee: NINTENDO CO., LTD., Kyoto (JP)

(21) Appl. No.: 13/186,888

(22) Filed: Jul. 20, 2011

(30) Foreign Application Priority Data
May 18, 2011 (JP) 2011-111751

(51) Int. Cl. G06T 15/00

(52) U.S. Cl. 345/419

(57) ABSTRACT

In a display control apparatus, a first content obtained from a server device is planarly displayed on a screen. When an operation to display a second content is detected, the second content is obtained from the server device. In the display control apparatus, it is determined whether or not the second content thus obtained is a stereoscopically viewable image. When the result of the determination is positive, the stereoscopically viewable image as the second content is stereoscopically displayed on the screen.

### CROSS REFERENCE TO RELATED APPLICATION

The disclosure of Japanese Patent Application No. 2011-111751, filed on May 18, 2011, is incorporated herein by reference.

### BACKGROUND OF THE INVENTION

1. Field of the Invention

The present invention relates to a computer readable storage medium having a display control program stored therein, a display control apparatus, a display control system, and a display control method. More particularly, the invention relates to: a computer readable storage medium having stored therein a display control program executed by a computer of a display control apparatus for displaying, on a screen, an image obtained from a server device such as a WEB server; a display control apparatus; a display control system; and a display control method.

2. Description of the Background Art

Display control apparatuses provided in personal computers, mobile telephone terminals, and the like have a so-called WEB browser function, by which a resource obtained by accessing a WEB server is analyzed to display a WEB page including text, images, and the like. The WEB browser function enables a user to view various WEB pages (refer to Japanese Published Patent Publication No. 2010-61504, for example).

On the other hand, various devices for performing stereoscopically viewable display in movies, games, and the like have been proposed. For example, Japanese Laid-Open Patent Publication No. 2004-7395 discloses a technique of taking an image of a virtual 3D space with a virtual stereo camera to generate a left-eye image and a right-eye image, and rendering these images shifted from each other to stereoscopically display a 3D object in the virtual 3D space.

By the way, the conventional WEB server and display control apparatus (a browser engine of the display control apparatus) disclosed in Japanese Published Patent Publication No. 2010-61504 are not configured to deal with a stereoscopically viewable image comprising a left-eye image and a right-eye image as disclosed in Japanese Laid-Open Patent Publication No. 2004-7395. Therefore, even when a stereoscopically viewable image is included in the contents supplied from the WEB server, the image is merely displayed planarly on the screen together with text and the like by the display control apparatus. That is, the display control apparatus cannot identify the image as a stereoscopically viewable image to stereoscopically display the image.

### SUMMARY OF THE INVENTION

Therefore, an object of the present invention is to provide: a computer readable storage medium having stored therein a display control program; a display control apparatus; a display control system; and a display control method, which enable, when a stereoscopically viewable image is included in the contents obtained from a server device, appropriate stereoscopically viewable display of the image.

A computer-readable storage medium according to the present invention is a computer-readable storage medium having stored therein a display control program executed by a computer of a display control apparatus for displaying, on a screen, an image obtained from a server device. The display control program causes the computer to function as first obtaining means, first display control means, operation detection means, second obtaining means, first determination means, and second display control means. The first obtaining means obtains a first content from the server device. The first display control means planarly displays, on the screen, the first content obtained by the first obtaining means. The operation detection means detects an operation to display a second content different from the first content. The second obtaining means obtains the second content from the server device when an operation to display the second content is detected by the operation detection means. The first determination means determines whether or not the second content obtained by the second obtaining means is a stereoscopically viewable image. The second display control means stereoscopically displays, on the screen, the stereoscopically viewable image as the second content, when the result of the determination by the first determination means is positive.

For example, when the first content is planarly displayed on the screen, an operation to display the second content linked to the first content (e.g., an operation to select a hyperlink embedded in the first content) becomes possible. When the operation to display the second content is detected, the second content is obtained from the server device. When the second content is obtained, it is determined whether or not the second content is a stereoscopically viewable image. When the result of the determination is that the second content is a stereoscopically viewable image, the second content is stereoscopically displayed on the screen as a stereoscopically viewable image. Accordingly, when a stereoscopically viewable image is included in the content obtained from the server device, the stereoscopically viewable image can be appropriately stereoscopically displayed.

Preferably, the second display control means planarly displays the second content on the screen when the result of the determination by the first determination means is negative.

The second display control means may stereoscopically display the second content, instead of the process of planarly displaying the second content by the first display control means.

In this configuration, an image, which is not identified as a stereoscopically viewable image and is planarly displayed like the first content by the first display control means, can be appropriately identified as a stereoscopically viewable image and stereoscopically displayed.

The display control program may cause the computer to further function as third obtaining means, and second determination means. The third obtaining means obtains the type of the second content when an operation to display the second content is detected by the operation detection means. The second determination means determines whether or not the type obtained by the third obtaining means is an image. In this case, the first determination means determines whether or not the second content is a stereoscopically viewable image when the result of the determination by the second determination means is positive.

In this configuration, when the type of the second content is an image, it is determined whether or not the second content is a stereoscopically viewable image. Therefore, it is possible to effectively avoid an unnecessary process of determining whether or not a second content which is not an image is a stereoscopically viewable image.

Preferably, the first display control means planarly displays the second content obtained by the second obtaining means, when the result of the determination by the second determination means is negative.

In this configuration, when the type of the second content is not an image, the second content is planarly displayed. Therefore, it is possible to avoid an unnecessary process of determining whether or not a second content which is not an image is a stereoscopically viewable image. As a result, an appropriate display process for the second content which is not an image can be rapidly performed.

The first determination means may determine whether or not the second content is a stereoscopically viewable image, based on whether or not the second content obtained by the second obtaining means includes a plurality of images.

In this configuration, it is possible to easily determine whether or not the second content is a stereoscopically viewable image.

The screen may include a first screen capable of planarly viewable display and a second screen capable of stereoscopically viewable display. In this case, the first display control means performs planarly viewable display by using the first screen, and the second display control means performs stereoscopically viewable display by using the second screen.

In this configuration, when the second content is a stereoscopically viewable image, the second content is stereoscopically displayed on the screen different from the screen where the first content is displayed. Therefore, the user can easily recognize that the second content is stereoscopically displayed as a stereoscopically viewable image on the screen.

The display control program may cause the computer to further function as storage control means for storing, in storage means, at least the stereoscopically viewable image stereoscopically displayed by the second display control means, in accordance with a user's input.

In this configuration, since the stereoscopically viewable image which is stereoscopically displayed on the screen is stored in the storage means, the user is allowed to easily view the image later.

The second display control means may display the second content in an area on the screen, which is different from an area on the screen where the first content is displayed by the first display control means.

The operation detection means detects an operation to display the second content, when the first content is planarly displayed by the first display control means.

The first content and the second content are contents of a WEB page, and a hyperlink linked to the second content may be embedded in the first content. In this case, the operation detection means detects an operation to specify the hyperlink. When the result of the determination by the first determination means is positive, the second display control means stereoscopically displays the stereoscopically viewable image as the second content, instead of that the first display control means planarly displays the content of the WEB page as the second content.

Further, a computer-readable storage medium according to the present invention is a computer-readable storage medium having stored therein a display control program executed by a computer of a display control apparatus for displaying, on a screen, an image obtained from a server device. The display control program causes the computer to function as operation detection means, obtaining means, determination means, and display control means. The operation detection means detects an operation to display a content. The obtaining means obtains, when an operation to display a content is detected by the operation detection means, the content from the server device. The determination means determines whether or not the content obtained by the obtaining means is a stereoscopically viewable image. The display control means stereoscopically displays, on the screen, the stereoscopically viewable image as the content, when the result of the determination by the determination means is positive.

In the display control apparatus, when an operation to display a content is detected, the content is obtained from the server device. When the content is obtained from the server device, it is determined whether or not the content is a stereoscopically viewable image. When the result of the determination is that the content is a stereoscopically viewable image, the content is stereoscopically displayed on the screen as a stereoscopically viewable image. Accordingly, when a content obtained from the server device is a stereoscopically viewable image, the stereoscopically viewable image can be appropriately stereoscopically displayed.

The present invention may be regarded as a display control apparatus for displaying, on a screen, an image obtained from a server device. The display control apparatus includes first obtaining means, first display control means, operation detection means, second obtaining means, first determination means, and second display control means. The first obtaining means obtains a first content from the server device. The first display control means planarly displays, on the screen, the first content obtained by the first obtaining means. The operation detection means detects an operation to display a second content different from the first content. The second obtaining means obtains the second content from the server device when an operation to display the second content is detected by the operation detection means. The first determination means determines whether or not the second content obtained by the second obtaining means is a stereoscopically viewable image. The second display control means stereoscopically displays, on the screen, the stereoscopically viewable image as the second content, when the result of the determination by the first determination means is positive.

The present invention may be regarded as a display control system for displaying, on a screen, an image obtained from a server device. The display control system includes first obtaining means, first display control means, operation detection means, second obtaining means, first determination means, and second display control means. The first obtaining means obtains a first content from the server device. The first display control means planarly displays, on the screen, the first content obtained by the first obtaining means. The operation detection means detects an operation to display a second content different from the first content. The second obtaining means obtains the second content from the server device when an operation to display the second content is detected by the operation detection means. The first determination means determines whether or not the second content obtained by the second obtaining means is a stereoscopically viewable image. The second display control means stereoscopically displays, on the screen, the stereoscopically viewable image as the second content, when the result of the determination by the first determination means is positive.

The present invention may be regarded as a display control method for displaying, on a screen, an image obtained from a server device. In this display control method, firstly, a first content is obtained from the server device. The obtained first content is planarly displayed on the screen. On the other hand, an operation to display a second content different from the first content is detected. When an operation to display the second content is detected, the second content is obtained from the server device. Next, it is determined whether or not the obtained second content is a stereoscopically viewable image. When it is determined that the second content is a stereoscopically viewable image, the stereoscopically viewable image as the second content is stereoscopically displayed on the screen.

According to the present invention, when it is determined that a content obtained from the server device is a stereoscopically viewable image, the content is displayed on the screen as a stereoscopically viewable image. Therefore, when a stereoscopically viewable image is included in a content obtained from the server device, the stereoscopically viewable image can be appropriately stereoscopically displayed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a game apparatus 10 in its opened state;

FIG. 2A is a left side view of the game apparatus 10 in its closed state;

FIG. 2B is a front view of the game apparatus 10 in its closed state;

FIG. 2C is a right side view of the game apparatus 10 in its closed state;

FIG. 2D is a rear view of the game apparatus 10 in its closed state;

FIG. 3 is a block diagram illustrating an internal configuration of the game apparatus 10;

FIG. 4 is a diagram illustrating a configuration of a network system 500;

FIG. 5 is a diagram illustrating scroll display of a WEB page;

FIG. 6A is a diagram illustrating a state where a content having a hyperlink embedded therein is selected;

FIG. 6B is a diagram illustrating a state where a content obtained from a link destination is stereoscopically displayed;

FIG. 7 is a memory map of a main memory 32;

FIG. 8 is a flowchart illustrating an example of a main process executed based on a browser engine 322 in the game apparatus 10; and

FIG. 9 is a flowchart illustrating, in detail, an image display process in step S19 in FIG. 8, which is executed based on an image display processing program 323 in the game apparatus 10.

### DESCRIPTION OF THE PREFERRED EMBODIMENTS

Hereinafter, an embodiment of the present invention will be described with reference to drawings as necessary.

### [Configuration of Game Apparatus 10]

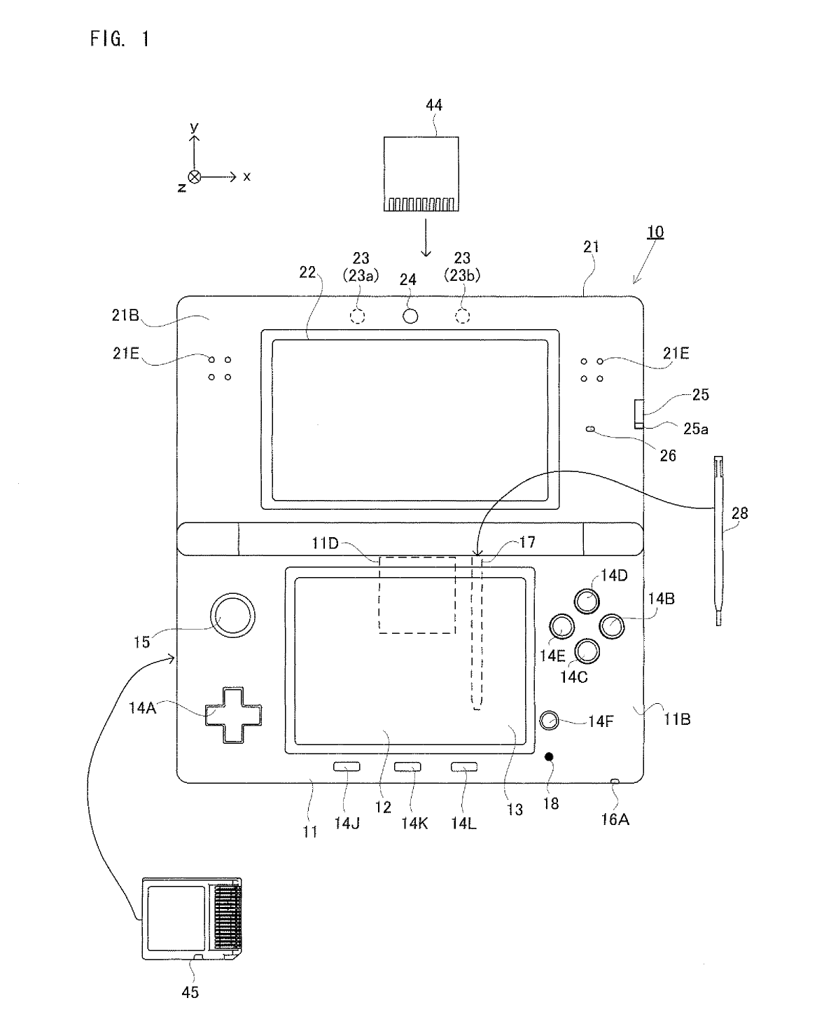

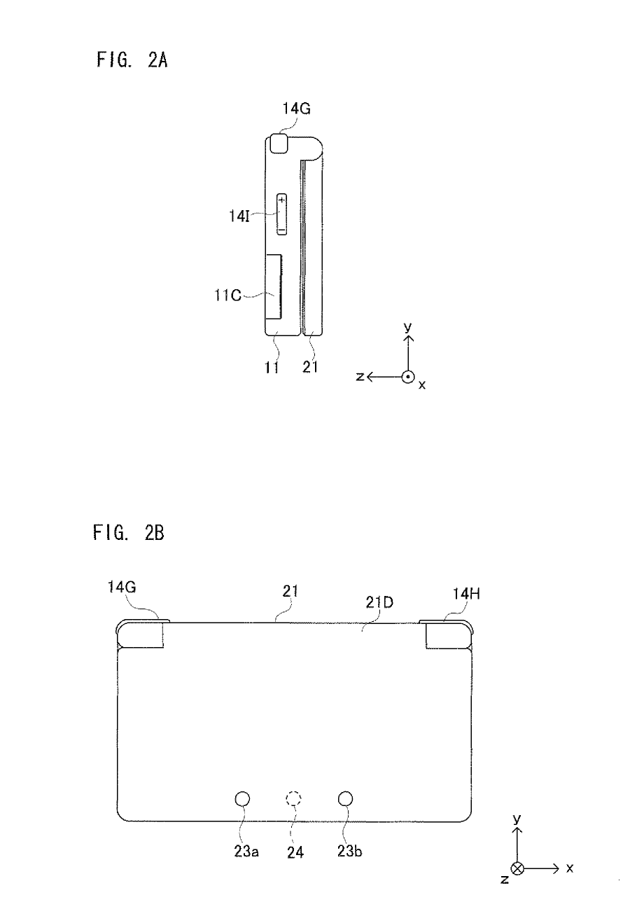

Firstly, a game apparatus 10 typifying a display control apparatus according to one embodiment of the present invention will be described. The game apparatus 10 is a hand-held game apparatus. As shown in FIG. 1, and FIGS. 2A to 2D, the game apparatus 10 includes a lower housing 11 and an upper housing 21. The lower housing 11 and the upper housing 21 are connected to each other so as to be openable and closable (foldable).

### [Description of Lower Housing 11]

As shown in FIG. 1, and FIGS. 2A to 2D, the lower housing 11 is provided with a lower LCD (Liquid Crystal Display) 12, a touch panel 13, operation buttons 14A to 14L, an analog stick 15, an LED 16A and an LED 16B, an insertion opening 17, and a microphone hole 18.

The touch panel 13 is mounted on the lower LCD 12, and functions as a coordinate input means. In the present embodiment, the touch panel 13 is a resistive film type touch panel. However, another pressing type touch panel, such as an electrostatic capacitance type touch pane, may be used. The insertion opening 17 (indicated by dashed line in FIG. 1 and FIG. 2D) is provided on the upper side surface of the lower housing 11 for accommodating a touch pen 28.

A cross button 14A (a direction input button 14A), a button 14B, a button 14C, a button 14D, a button 14E, a power button 14F, a selection button 14J, a HOME button 14K, and a start button 14L are provided on the inner side surface (main surface) of the lower housing 11.

The analog stick 15 is a device for indicating a direction.

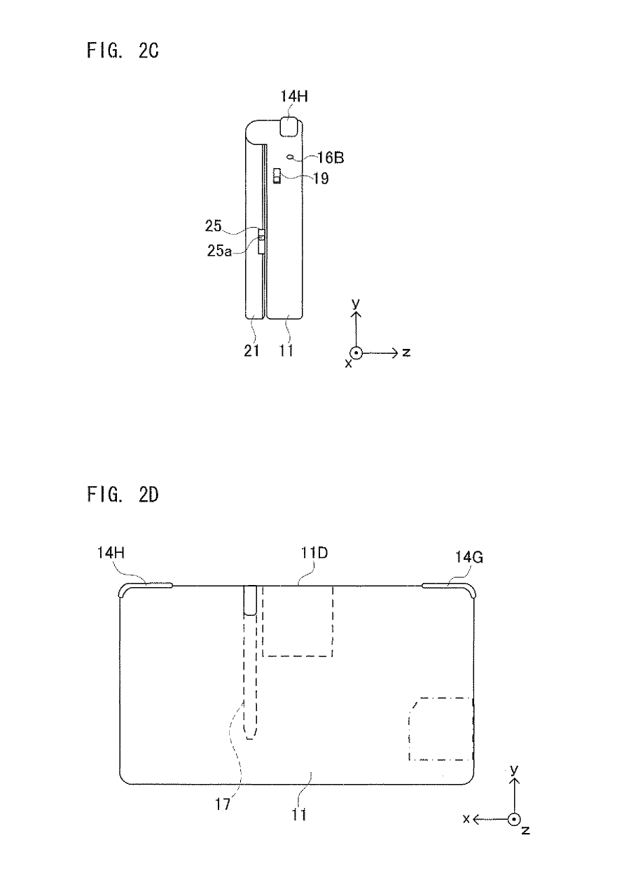

The microphone hole 18 is provided on the inner side surface of the lower housing 11. Under the microphone hole 18, a microphone 42 (see FIG. 3) is provided as a sound input device described below.

As shown in FIG. 2B and FIG. 2D, the L button 14G and the R button 14H are provided on the upper side surface of the lower housing 11. As shown in FIG. 2A, a sound volume button 14I is provided on the left side surface of the lower housing 11 for adjusting a sound volume of a speaker 43 (shown in FIG. 3) of the game apparatus 10.

As shown in FIG. 2A, a cover section 11C is provided on the left side surface of the lower housing 11 so as to be openable and closable. Inside the cover section 11C, a connector is provided for electrically connecting between the game apparatus 10 and an external data storage memory 45.

As shown in FIG. 2D, an insertion opening 11D through which an external memory 44 is inserted is provided on the upper side surface of the lower housing 11.

As shown in FIG. 1 and FIG. 2C, a first LED 16A for notifying a user of an ON/OFF state of a power supply of the game apparatus 10 is provided on the lower side surface of the lower housing 11. A second LED 16B for notifying a user of an establishment state of a wireless communication of the game apparatus 10 is provided on the right side surface of the lower housing 11. The game apparatus 10 can make wireless communication with other devices, and a wireless switch 19 for enabling/disabling the function of the wireless communication is provided on the right side surface of the lower housing 11 (see FIG. 2C).

### [Description of Upper Housing 21]

As shown in FIG. 1 and FIG. 2, the upper housing 21 is provided with an upper LCD (Liquid Crystal Display) 22, an outer imaging section 23 (an outer imaging section (left) 23a and an outer imaging section (right) 23b), an inner imaging section 24, a 3D adjustment switch 25, and a 3D indicator 26.

The upper LCD 22 is a display device capable of displaying a stereoscopically viewable image. Specifically, the upper LCD 22 is a display device which allows a user to view a stereoscopic image with her/his naked eyes by utilizing parallax barrier. The upper LCD 22 allows a user to view an image for a left eye with her/his left eye, and an image for a right eye with her/his right eye by utilizing a parallax barrier, so that a stereoscopic image (stereoscopically viewable image) exerting a stereoscopic effect for a user can be displayed. Further, the upper LCD 22 may disable the parallax barrier. When the parallax barrier is disabled, an image can be displayed in a planar manner. Thus, the upper LCD 22 is a display device capable of switching between a stereoscopic display mode for displaying a stereoscopically viewable image and a planar display mode for displaying an image in a planar manner (for displaying a planar view image). The switching of the display mode is performed by means of, for example, the 3D adjustment switch 25 described below.

Two imaging sections (23a and 23b) provided on the outer side surface 21D of the upper housing 21 are generically referred to as the outer imaging section 23. The outer imaging section (left) 23a and the outer imaging section (right) 23b can be used as a stereo camera according to a program executed by the game apparatus 10.

The inner imaging section 24 is positioned on the inner side surface 21B of the upper housing 21, and acts as an imaging section which has an imaging direction which is the same direction as the inward normal direction of the inner side surface.

The 3D adjustment switch 25 is a slide switch, and is used for switching a display mode of the upper LCD 22 as described above. The 3D adjustment switch 25 is used for adjusting the stereoscopic effect of a stereoscopically viewable image (stereoscopic image) which is displayed on the upper LCD 22. A slider 25a of the 3D adjustment switch 25 can be slid to any position in a predetermined direction (upward/downward direction), and a display mode of the upper LCD 22 is determined according to the position of the slider 25a. Further, the viewable mariner for the stereoscopic image is adjusted according to the position of the slider 25a.

The 3D indicator 26 is implemented as LEDs for indicating whether the upper LCD 22 is in the stereoscopic display mode.

Further, a speaker hole 21E is provided on the inner side surface of the upper housing 21. Sound is outputted through the speaker hole 21E from the speaker 43 described below.

### [Internal Configuration of Game Apparatus 10]

Next, an internal electrical configuration of the game apparatus 10 will be described with reference to FIG. 3. As shown in FIG. 3, the game apparatus 10 includes, in addition to the components described above, electronic components such as an information processing section 31, a main memory 32, an external memory interface (external memory I/F) 33, an external data storage memory I/F 34, an internal data storage memory 35, a wireless communication module 36, a local communication module 37, a real-time clock (RTC) 38, an acceleration sensor 39, a power supply circuit 40, an interface circuit (I/F circuit) 41, and the like.

The information processing section 31 includes: a CPU (Central Processing Unit) 311 for executing a predetermined program; a GPU (Graphics Processing Unit) 312 for performing image processing; and a VRAM (Video RAM) 313. The CPU 311 executes a program stored in a memory (for example, the external memory 44 connected to the external memory I/F 33, or the internal data storage memory 35) in the game apparatus 10, to execute a process based on the program. The program executed by the CPU 311 may be obtained from another device through communication with the other device. The GPU 312 generates an image according to an instruction from the CPU 311, and renders the image in the VRAM 313. The image rendered in the VRAM 313 is outputted to the upper LCD 22 and/or the lower LCD 12, and the image is displayed on the upper LCD 22 and/or the lower LCD 12.

The external memory I/F 33 is an interface for detachably connecting to the external memory 44. The external data storage memory I/F 34 is an interface for detachably connecting to the external data storage memory 45.

The main memory 32 is volatile storage device used as a work area and a buffer area for (the CPU 311 of) the information processing section 31.

The external memory 44 is non-volatile storage device for storing, for example, a program executed by the information processing section 31. The external memory 44 is implemented as, for example, a read-only semiconductor memory.

The external data storage memory 45 is implemented as a non-volatile readable and writable memory (for example, a NAND flash memory), and is used for storing any data.

The internal data storage memory 35 is implemented as a non-volatile readable and writable memory (for example, a NAND flash memory), and is used for storing predetermined data. For example, data and/or programs downloaded through the wireless communication module 36 by wireless communication are stored in the internal data storage memory 35.

The wireless communication module 36 has a function of connecting to a wireless LAN by using a method compliant with, for example, IEEE 802.11.b/g standard. The local communication module 37 has a function of performing wireless communication with the same type of game apparatus in a predetermined communication method (for example, a communication based on an independent protocol, or infrared communication).

The acceleration sensor 39 detects magnitudes of accelerations (linear accelerations) in the directions of the straight lines along the three axial (xyz axial) directions, respectively. The information processing section 31 can receive data (acceleration data) representing accelerations detected by the acceleration sensor 39, and detect an orientation and a motion of the game apparatus 10.

The RTC 38 counts time and outputs the counted time to the information processing section 31. The information processing section 31 calculates a current time (date) based on the time counted by the RTC 38. The power supply circuit 40 controls power to be supplied from a power supply (the rechargeable battery) of the game apparatus 10, and supplies power to each component of the game apparatus 10.

The touch panel 13, the microphone 42, and the speaker 43 are connected to the I/F circuit 41. The I/F circuit 41 includes a sound control circuit for controlling the microphone 42 and the speaker 43 (amplifier), and a touch panel control circuit for controlling the touch panel. The sound control circuit performs A/D conversion and D/A conversion on the sound signal, and converts the sound signal to a predetermined form of sound data, for example. The touch panel control circuit generates a predetermined form of touch position data based on a signal outputted from the touch panel 13, and outputs the touch position data to the information processing section 31. The information processing section 31 obtains the touch position data to recognize a position at which an input on the touch panel 13 is made.

The operation button 14 includes the operation buttons 14A to 14L described above. Operation data representing an input state of each of the operation buttons 14A to 14I is outputted from the operation button 14 to the information processing section 31, and the input state indicates whether or not each of the operation buttons 14A to 14I has been pressed.

The lower LCD 12 and the upper LCD 22 are connected to the information processing section 31. Specifically, the information processing section 31 is connected to an LCD controller (not shown) of the upper LCD 22, and causes the LCD controller to set the parallax barrier to ON or OFF. When the parallax barrier is set to ON in the upper LCD 22, a right-eye image and a left-eye image, which are stored in the VRAM 313 of the information processing section 31, are outputted to the upper LCD 22. More specifically, the LCD controller alternately repeats reading of pixel data of the right-eye image for one line in the vertical direction, and reading of pixel data of the left-eye image for one line in the vertical direction, thereby reading, from the VRAM 313, the right-eye image and the left-eye image. Thus, an image to be displayed is divided into the right-eye images and the left-eye images each of which is a rectangle-shaped image having one line of pixels aligned in the vertical direction, and an image, in which the rectangle-shaped image for the left eye which is obtained through the division, and the rectangle-shaped image for the right eye which is obtained through the division are alternately aligned, is displayed on the screen of the upper LCD 22. A user views the images through the parallax barrier in the upper LCD 22, so that the right-eye image is viewed by the user's right eye, and the left-eye image is viewed by the user's left eye. Thus, the stereoscopically viewable image is displayed on the screen of the upper LCD 22.

The outer imaging section 23 and the inner imaging section 24 each take an image according to an instruction from the information processing section 31, and data of the taken images are outputted to the information processing section 31.

The 3D adjustment switch 25 transmits, to the information processing section 31, an electrical signal based on the position of the slider 25a.

The information processing section 31 controls whether or not the 3D indicator 26 is to be lit up. For example, the information processing section 31 lights up the 3D indicator 26 when the upper LCD 22 is in the stereoscopic display mode.

The configuration of the hardware described above is only an exemplary configuration. The configuration of the game apparatus 10 may be modified as necessary.

### [Configuration of Network System 500]

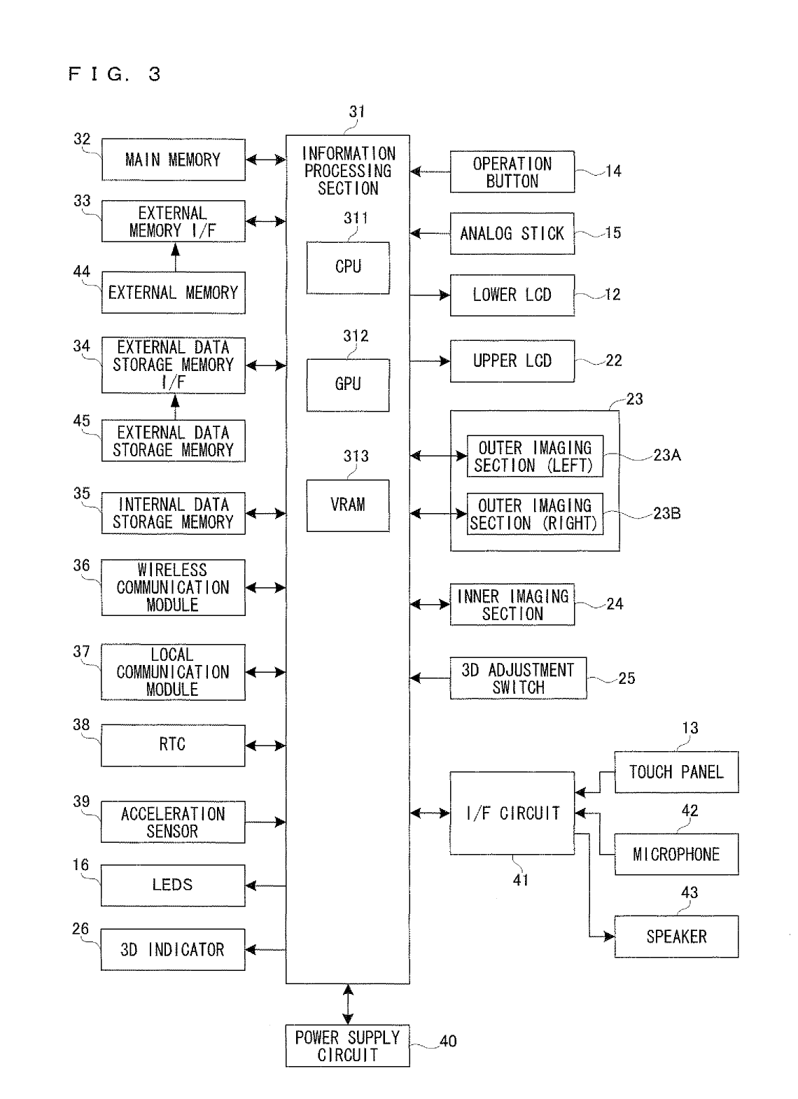

FIG. 4 is a diagram illustrating a network system 500 constituted by game apparatuses 10 (10A, 10B, and 10C) and a WEB server 100. As shown in FIG. 4, each game apparatus 10 is communicably connected to the WEB server 100 (an example of a server device) via the Internet.

The WEB server 100 is configured to execute an application program for performing communication in conformity with HTTP (Hyper Text Transfer Protocol). Based on the application program, the WEB server 100 returns, to the game apparatus 10, resources such as HTML text and images described by HTML (Hyper Text Markup Language), in response to a connection request from the game apparatus 10.

The game apparatus 10 is equipped with protocols such as HTTP and a WEB browser, and is connectable to a network such as the Internet via the wireless communication module 36. Therefore, the game apparatus 10 is allowed to obtain, from the WEB server 100 or the like, the HTML text, images, and the like published on the network, and display the same.

Although FIG. 4 shows a state where three game apparatuses 10 and one WEB server 100 are communicably connected, the number of game apparatuses 10 and the number of WEB servers 100, which constitute the network system 500, are not particularly limited. Further, in the present embodiment, the network system 500 is a computer network system constructed by utilizing the Internet. However, the network system 500 may be constructed by utilizing a computer network such as LAN. That is, the server device is not limited to the WEB server 100, and any server may be adopted so long as it has a function of transmitting contents (HTML text, images, and the like) to the game apparatus 10.

### [Outline of Contents Display Process]

The following will describe the outline of a process of displaying contents in the game apparatus 10. In the game apparatus 10, a program, which is loaded from the external memory 44 or the internal data storage memory 35 to the main memory 32, is executed by a CPU 311 of the information processing section 31. Thereby, a user is allowed to freely scroll a WEB page displayed on the lower LCD 12 by means of the touch panel 13. In addition, the user is allowed to select a hyperlink embedded in the WEB page, and display a content obtained from a link destination.

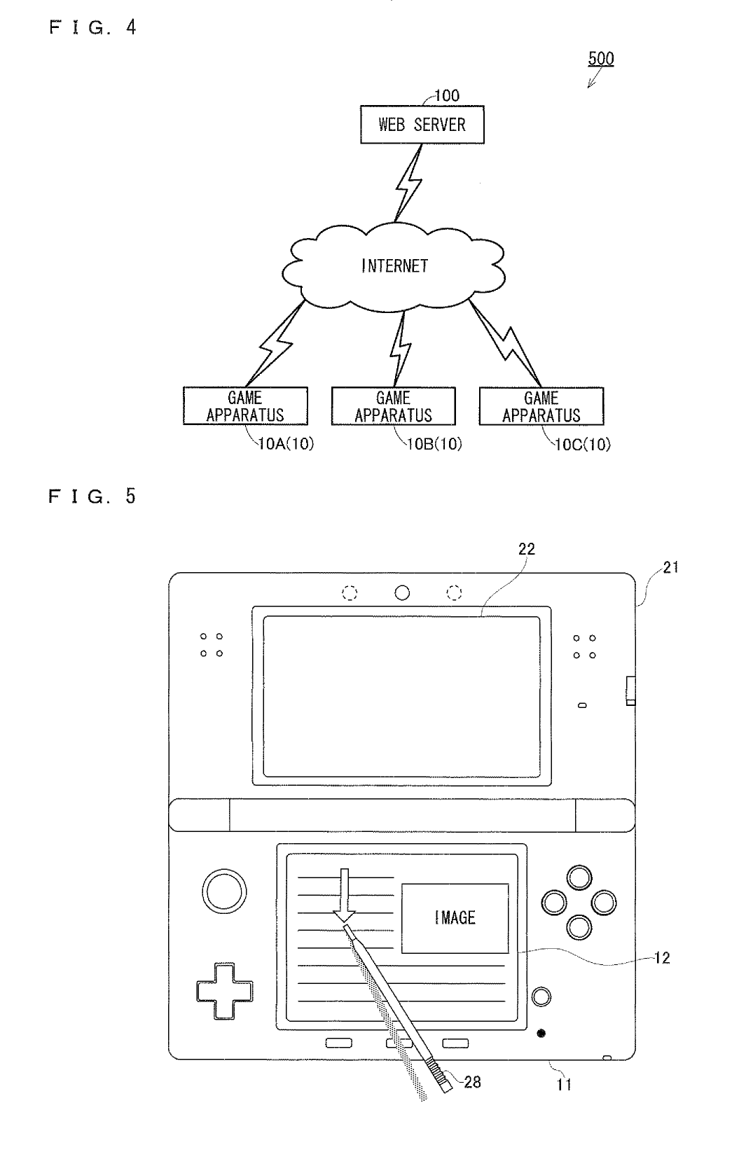

FIG. 5 is a diagram illustrating scroll display of a WEB page. As shown in FIG. 5, a WEB page including HTML text and images is displayed on the lower LCD 12. In this state, if the user touches, with the touch pen 28, an arbitrary position on the WEB page, and slides the touch pen 28, the WEB page is scroll-displayed by an amount corresponding to the amount of sliding of the touch pen 28. Although in FIG. 5 the touch pen 28 is slid downward and the WEB page is scrolled downward, the scroll direction of the WEB page is not limited thereto.

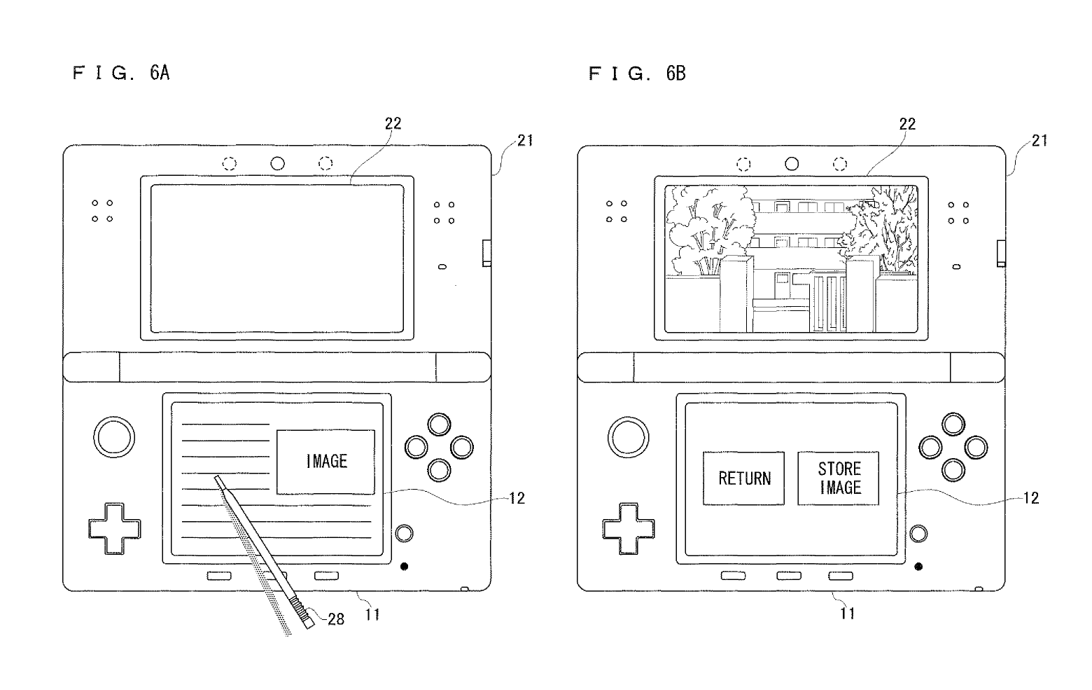

FIGS. 6A and 6B are diagrams illustrating a process up to stereoscopically viewable display of an image on the upper LCD 22. Specifically, FIG. 6A is a diagram illustrating a state where a content having a hyperlink embedded therein is selected. FIG. 6B is a diagram illustrating a state where a content from a link destination is stereoscopically displayed. When a user performs an operation to specify a WEB page, the WEB page including a content (first content) such as HTML text, image, or the like is planarly displayed on the lower LCD 12 as shown in FIG. 6A. At this time, even if the WEB page includes a stereoscopically viewable image, the WEB page is planarly displayed on the lower LCD 12. A hyperlink is embedded in an arbitrary position in the WEB page. If a position on the touch panel 13, which corresponds to the position where the hyperlink is present, is touched with the touch pen 28 and then the touch pen 28 is moved away from the touch panel 13 without being slid, it is determined whether or not a content (second content) in a link destination is a stereoscopically viewable image. If the content from the link destination is a stereoscopically viewable image, the content is stereoscopically displayed on the upper LCD 22 (refer to FIG. 6B). The stereoscopically viewable image is full-screen displayed on the upper LCD 22. At this time, a button for returning to display of the WEB page and a button for storing the content of the stereoscopically viewable image are displayed on the lower LCD 12. The user is allowed to display the WEB page again or store the content of the stereoscopically viewable image in the main body of the game apparatus 10 (e.g., the external data storage memory 45) by pointing either of the buttons with the touch pen 28. This process is performed when a stereoscopically viewable image generated in the game apparatus 10 is uploaded to the WEB server 100, and the stereoscopically viewable image is stored in the link destination.

In the following description, touching the touch panel 13 with the touch pen 28 is referred to as “touch on”, and moving the touch pen 28 away from the touch panel 13 is referred to as “touch of”. A position where the touch pen 28 touches on the touch panel 13 is referred to as “touch-on position”, and a position on the touch panel 13, which has lately been touched with the touch pen 28 before “touch off” of the touch pen 28, is referred to as “touch-off position”.

### [Memory Map]

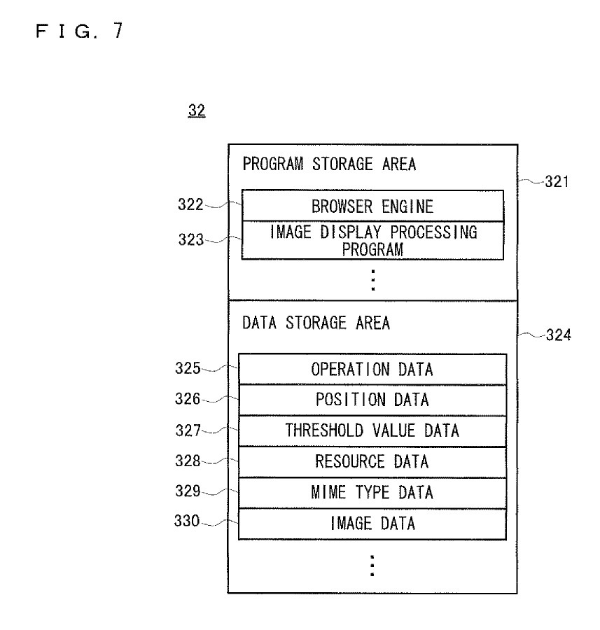

Hereinafter, data stored in the main memory 32 will be described with reference to FIG. 7. FIG. 7 shows a memory map of the main memory 32. As illustrated in FIG. 7, the main memory 32 includes a program storage area 321 and a data storage area 324. In the program storage area 321, display control programs to be executed by the CPU 311 is stored. In the data storage area 324, various data are stored, which are necessary for a process of displaying HTML text and images. The programs in the program storage area 321 and a portion of data in the data storage area 324 are previously stored in the external memory 44 or the internal data storage memory 35, and are loaded into the main memory 32 when a WEB page is displayed.

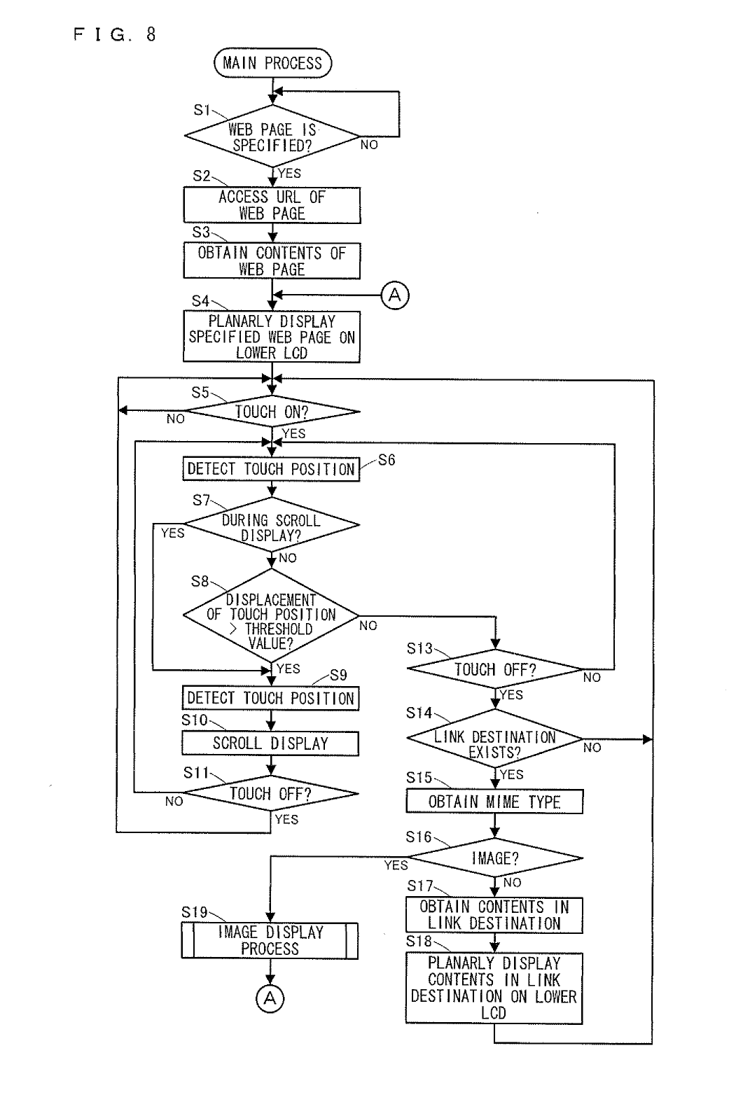

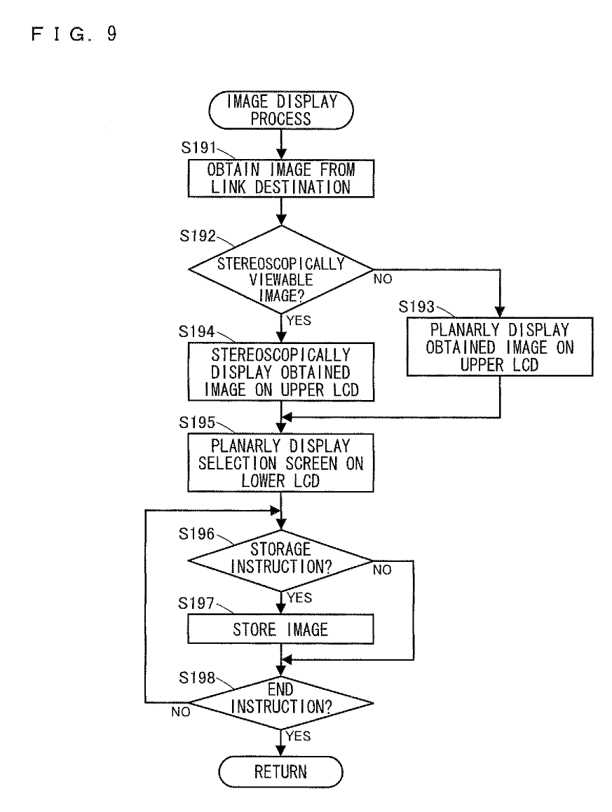

In the program storage area 321, a browser engine 322, an image display processing program 323, and the like are stored as the display control programs. The browser engine 322 has functions similar to those of general browser engines, and causes the information processing section 31 to execute a series of process steps shown in the flowchart of FIG. 8. The image display processing program 323 causes the information processing section 31 to execute a series of process steps shown in the flowchart of FIG. 9.

The browser engine 322, in conformity with. HTTP, transmits a connection request to the WEB server 100, and analyzes a resource returned from the WEB server 100. Based on the result of analysis, the browser engine 322 causes the information processing section 31 to execute a process of planarly displaying a WEB page including HTML text and images on the lower LCD 12. Further, the browser engine 322 causes the information processing section 31 to execute a process instructed by means of the touch panel 13 (e.g., scroll display of the WEB page, or a request, to the WEB server 100, for a resource from a link destination specified by a hyperlink address).

The browser engine 322 has a function of operating in cooperation with the image display processing program 323 which is a program other than the browser engine 322. Specifically, when a resource specified by a hyperlink is an image, processes based not on the browser engine 322 but on the image display processing program 323 are executed by the information processing section 31.

When a resource from a link destination specified by a hyperlink address is an image, the image display processing program 323, instead of the browser engine 322, obtains the resource (image, in this embodiment) from the link destination, and causes the information processing section 31 to execute a process of determining whether or not the obtained image is a stereoscopically viewable image. The image display processing program 323 causes the information processing section 31 to execute a process of stereoscopically displaying the resource on the upper LCD 22 when the resource is a stereoscopically viewable image, or a process of planarly displaying the resource on the lower LCD 12 when the resource is a planarly viewable image.

While the outline of the process based on the browser engine 322 and the image display processing program 323 has been described above, the details of the process executed by the information processing section 31 based on the browser engine 322 and the image display processing program 323 will be described later with reference to FIGS. 8 and 9.

In the data storage area 324, operation data 325, position data 326, threshold value data 327, resource data 328, MIME type data 329, and image data 330, and the like are stored.

The operation data 325 represents an operation performed by a user on any one of the operation buttons 14A to 14E and 14G to 14H, the analog stick 15, and the touch panel 13. Based on operation information represented by the operation data 325, a process of determining whether or not a WEB page is specified is performed.

The position data 326 represents a touch position (designated position) on the touch panel 13 by the touch pen 28. While the WEB page is being displayed, a process of determining whether or not an operation to select a hyperlink is performed, and a process of determining whether or not execution of scroll display of the WEB page is instructed, are performed based on a touch position represented by the position data 326.

The threshold value data 327 represents a threshold value used for the process of determining whether or not execution of scroll display of a WEB page is instructed. The determination process based on the threshold value data 327 will be described later in detail.

The resource data 328 represents resources constituting a WEB page, such as HTML text and images.

The MIME type data 329 represents the type of a content stored in a link destination specified by a hyperlink address. A MIME type obtained from the WEB server 100 by the game apparatus 10 is stored as MIME type data 329 in the data storage area 324. This MIME type indicates a data format. In the game apparatus 10, a process of identifying the type of a content from a link destination is executed based on the MIME type.

When the content from the link destination is an image, the image data 330 is data of the image obtained from the link destination.

It should be noted that such as image data (not shown) obtained by image taking by the outer imaging section 23 or the inner imaging section 24 is also stored in the data storage area 324. Such data is not directly related to the present invention, and the detailed description thereof is not given in the present embodiment.

### [Description of Main Process by Browser Engine 322]

The following will describe, with reference to FIG. 8, a main process to be executed by the game apparatus 10 based on the browser engine 322. FIG. 8 is a flowchart illustrating an example of a main process to be executed based on the browser engine 322 in the game apparatus 10.

Firstly, the CPU 311 determines, based on operation information represented by the operation data 325, whether or not a WEB page a user desires to view is specified (step S1). When the CPU 311 determines that the WEB page is not specified (NO in step S1), the process returns to step S1.

When the CPU 311 determines that the WEB page is specified (YES in step S1), the CPU 311 transmits a connection request to the WEB server 100, and accesses the URL of the specified WEB page (step S2). Then, the CPU 311 receives a resource transmitted from the WEB server 100 to obtain the resource of the WEB page (step S3). That is, the CPU 311 obtains contents including an image from the WEB server 100. The resource obtained in the process of step 53 is stored as resource data 328 in the data storage area 324.

Next, the CPU 311 analyzes the resource represented by the resource data 328. Then, based on the result of analysis, the CPU 311 planarly displays, on the lower LCD 12, the WEB page including a content (first content) such as HTML text, image, or the like (step S4).

After the WEB page is planarly displayed on the lower LCD 12, the CPU 311 determines, based on touch position data supplied from the touch panel control circuit in the I/F circuit 41, whether or not the touch pen 28 touches on the touch panel 13 (step S5). When the CPU 311 determines that the touch pen 28 does not touch on the touch panel 13 (NO in step S5), the process returns to step S5.

When the CPU 311 determines that the touch pen 28 touches on the touch panel 13 (YES in step S5), the CPU 311 detects, based on the touch position data, a touch position which is touched by the touch pen 28 on the touch panel 13 (step S6). In the present embodiment, the horizontal direction and the vertical direction of the screen of the lower LCD 12 are the X-axis direction and the Y-axis direction, respectively, and a touch position is represented by two-dimensional coordinates (X, Y). In this way, the CPU 311 detects, as a touch position, a position on the screen of the lower LCD 12, which is designated on the touch panel 13 by the touch pen 28, and stores the result of detection as position data 326 in the data storage area 324.

Subsequently to the process of step S6, the CPU 311 determines, based on the information stored in the data storage area 324, whether or not the WEB page planarly displayed on the lower LCD 12 is being scroll-displayed (step S7). When the CPU 311 determines that the WEB page is being scroll-displayed (YES in step S7), the process goes to step S9 described later.

On the other hand, when the result of determination is that the WEB page is not being scroll-displayed (NO in step S7), the CPU 311 determines whether or not a displacement of the touch position exceeds a preset threshold value (step S8). Specifically, the CPU 311 determines whether or not a displacement of the touch position (a displacement from the touch-on position to the current touch position), which is represented by the position data 326, exceeds the threshold value represented by the threshold value data 327.

When the result of determination is that the displacement of the touch position exceeds the threshold value (YES in step S8), the CPU 311 determines that the user instructs scroll of the WEB page, and executes the following processes. That is, the CPU 311 detects a touch position (step S9) as in step S6. Then, the CPU 311 scroll-displays the entire WEB page (step S10). Specifically, the CPU 311 determines a scroll direction (a direction from two-dimensional coordinates (X1, Y1) to two-dimensional coordinates (X1, Y2)) based on the two-dimensional coordinates (X1, Y1) of the touch position obtained in step S6 and the two-dimensional coordinates (X1, Y2) of the touch position obtained in step S9. Then, the CPU 311 determines a scroll width corresponding to the distance between the two two-dimensional coordinates (the amount of movement of the WEB page on the screen of the lower LCD 12). Thereafter, the CPU 311 scroll-displays the WEB page on the screen of the lower LCD 12, by the determined scroll width, along the determined scroll direction, as described with reference to FIG. 5.

As described above, when the touch position is moved from a point on an arbitrary content by a user's drag operation, the CPU 311 scroll-displays the WEB page so that the WEB page moves by the scroll width corresponding to the amount of movement of the touch position, along the direction in which the touch position is moved.

Subsequently to the process of step S10, the CPU 311 determines whether or not the touch pen 28 is moved away from the touch panel 13 (touch off), based on presence/absence of touch position data from the touch panel control circuit (step S11). When the CPU 311 determines that the touch pen 28 is not moved away from the touch panel 13 (NO in step S11), the process returns to step S6. On the other hand, when the CPU 311 determines that the touch pen 28 is moved away from the touch panel 13 (YES in step S11), the process returns to step S5.

On the other hand, when the result of determination is that the displacement of the touch position does not exceed the threshold value (NO in step S8), the CPU 311 determines whether or not the touch pen 28 is moved away from the touch panel 13 (touch off) (step S13). When the CPU 311 determines that the touch pen 28 is not moved away from the touch panel 13 (NO in step S13), the process returns to step S6.

By the way, a hyperlink is embedded in the WEB page planarly displayed on the lower LCD 12. Therefore, when a position on the touch panel 13, which corresponds to the position where the hyperlink is present, is touched by the touch pen 28 (touch on) and then the touch pen is moved away from the position (touch off), it is possible to display a content (second content) of a link destination, which is different from the content (first content) included in the WEB page displayed on the lower LCD 12.

In order to realize such process, when the result of determination is that the touch pen 28 is moved away from the touch panel 13 (touch off) (YES in step S13), the CPU 311 determines whether or not a link destination is present, based on whether or not a hyperlink is embedded in a position corresponding to the touch-off position in the WEB page (step S14). When the CPU 311 determines that no link destination is present (no hyperlink is embedded in the touch-off position in the WEB page) (NO in step S14), the process returns to step S5. Conversely, when the CPU 311 determines that a link destination is present (a hyperlink is embedded in the touch-off position in the WEB page) (YES in step S14), a content obtained from the link destination is displayed, which is described later in detail.

In this way, the CPU 311 detects an operation of displaying a content which is different from the content planarly displayed on the lower LCD 12, in accordance with the two determination processes of steps S13 and S14.

When the CPU 311 determines that a link destination is present (YES in step S14), in advance of obtaining a content from the link destination, the CPU 311 obtains the MIME type of the content from the WEB server 100 (step S15). That is, the CPU 311 obtains the type of the content in the link destination.

A MIME type is a text string in a format of “type name/subtype name”. When the content obtained from the link destination is, for example, HTML text, the MIME type of the content is represented by a text string “text/html”. When the content obtained from the link destination is, for example, a JPEG image, the MIME type of the content is represented by a text string “image/jpeg”. When the content obtained from the link destination is, for example, a multipicture format stereoscopically viewable image, the MIME type of the content is represented by a text string “image/mpo”. Accordingly, by referring to the type name of the MIME type obtained from the WEB server 100, it is possible to determine whether or not the content from the link destination is an image.

Therefore, subsequently to the process of step S15, the CPU 311 determines whether or not the type of the content from the link destination is an image, based on whether the MIME type obtained in step S15 is “image/jpeg” or “image/mpo” (step S16). If the content obtained from the link destination is a GIF image, the MIME type of the content is “image/gif”. However, since it is defined that this content is not a stereoscopically viewable image, the CPU 311 determines that the type of the content is not an image. That is, in step S16, the CPU 311 determines whether or not there is a possibility that the type of the content from the link destination is a stereoscopically viewable image, based on the subtype name of the MIME type obtained in step S15. Since data of a multipicture format stereoscopically viewable image has a JPEG format data structure and is composed of images in a plurality of viewpoints. Therefore, even when the MIME type is “image/jpeg”, there is a possibility that the type of the content from the link destination is a stereoscopically viewable image.

When the CPU 311 determines that the type of the content is not an image (NO in step S16), the CPU 311 obtains the content in the link destination from the WEB server 100 (step S17). Then, the CPU 311 analyzes the content (resource) obtained in step S17, and causes the GPU 312 to planarly display the content (e.g., HTML text) on the lower LCD 12 (step S18). The process of step S18 is performed in a similar manner to the process of step S4. In step S18, the content obtained from the link destination may be planarly displayed on the upper LCD 22 which is set in the planar display mode, instead of planarly displaying the content on the lower LCD 12.

On the other hand, when the CPU 311 determines that the type of the content is an image (YES in step S16), the CPU 311 calls the image display processing program 323, and executes an image display process based on the image display processing program 323 (step S19).

### [Description of Image Display Process by Image Display Processing Program 323]

The following will describe, with reference to FIG. 9, an image display process to be executed by the game apparatus 10 based on the image display processing program 323 when a content from a link destination is an image. FIG. 9 is a flowchart specifically illustrating the image display process of step S19 in FIG. 8.

When the CPU 311 determines that the type of the content from the link destination is an image (YES in step S16), the CPU 311 obtains the image (second content) in the link destination from the WEB server 100 as shown in FIG. 9 (step S191). If the linked WEB server is different from the WEB server 100, the image is obtained from the different WEB server. The image obtained in the process of step S191 is stored as image data 330 in the data storage area 324. Then, the CPU 311 determines whether or not the image represented by the image data 330 is a stereoscopically viewable image (step S192). Specifically, the CPU 311 analyzes, for example, a header (auxiliary information) of the image data 330, and determines whether or not the image represented by the image data 330 is a stereoscopically viewable image, based on whether or not the image data 330 includes a plurality of images.

In the present embodiment, the CPU 311 determines whether or not the image represented by the image data 330 is a stereoscopically viewable image, based on the header of the image data 330. The reason is as follows. If the MIME type is not appropriately set (for example, if the subtype name of the MIME type is not appropriately set), the CPU 311 might fail to accurately determine whether or not the image in the link destination is a stereoscopically viewable image.

Further, if the stereoscopically viewable image is a multipicture format stereoscopically viewable image, an individual image, which is different from an individual image as a head image, is included in the image data 330. Therefore, the process of determining whether or not the image is a stereoscopically viewable image may be performed based on presence/absence of the individual image other than the head image, instead of referring to the header of the image data 330.

When the CPU 311 determines that the image obtained from the link destination is not a stereoscopically viewable image (NO in step S192), the CPU 311 planarly displays the obtained image on the upper LCD 22 (step S193). In step S193, the image obtained from the link destination may be planarly displayed not on the upper LCD 22 but on the lower LCD 12.

On the other hand, when the CPU 311 determines that the image obtained from the link destination is a stereoscopically viewable image (YES in step S192), the CPU 311 stereoscopically displays the obtained image on the upper LCD 22 (step S194) as described with reference to FIG. 6. Specifically, the CPU 311 causes the GPU 312 to perform a rendering process with a head image included in the image data 330 being a left-eye image and an individual image that follows the head image being a right-eye image, and then stereoscopically display the stereoscopically viewable image thus obtained on the upper LCD 22.

As described above, the CPU 311 stereoscopically displays the content obtained from the link destination on the upper LCD 22 based on the image display processing program 323, instead of planarly displaying the content on the lower LCD 12 based on the browser engine 322.

Accordingly, when the browser engine 322 does not have a function of appropriately identifying the image obtained from the link destination as a stereoscopically viewable image, and stereoscopically displaying the image, it is possible to appropriately identify the image as a stereoscopically viewable image and stereoscopically display the image. That is, it is possible to stereoscopically display the stereoscopically viewable image obtained from the link destination, without making a significant change to the browser engine 322.

Subsequently to the process of steps S193 or S 194, as shown in FIG. 6B, the CPU 311 planarly displays, on the lower LCD 12, in place of the WEB page, the selection screen including the button for storing the image and the button for returning to display of the WEB page (step S195).

Next, the CPU 311 determines whether or not storage of the image is instructed, based on whether or not an operation of selecting, with the touch pen 28, the button for storing the image (refer to FIG. 6B) has been performed on the touch panel 13 (step S196). When it is determined that storage of the image is instructed (YES in step S196), the CPU 311 stores the image displayed on the upper LCD 22 (step S197). Specifically, when the stereoscopically viewable image is displayed on the upper LCD 22 by the process of step S194, the CPU 311 stores the stereoscopically viewable image in the external data storage memory 45, for example. When the planarly viewable image is displayed on the upper LCD 22 by the process of step S193, the CPU 311 stores the planarly viewable image in the external data storage memory 45, for example.

After the process of step S197 is done or when the result of determination is that storage of the image is not instructed (NO in step S196), the CPU 311 determines whether or not an end instruction is issued, which ends the display of the image on the upper LCD 22 and returns the display to the WEB page (step S198). Specifically, the CPU 311 determines whether or not an operation of selecting, with the touch pen 28, the button for returning to display of the WEB page (refer to FIG. 6B) is performed on the touch panel 13. When the CPU 311 determines that no end instruction is issued (NO in step S198), the process returns to step S196. Conversely, when the CPU 311 determines that an end instruction is issued (YES in step S198), the process returns to step S4, and the WEB page is again displayed on the lower LCD 12.

In the present embodiment, the process of obtaining the MIME type (step S15) and the process of determining whether or not the type of the content obtained from the link destination is an image (step S16) are executed by the browser engine 322. However, these processes may be executed by the image display processing program 323. In this case, if the content from the link destination is not an image, the image display processing program 323 may return the process to the browser engine 322.

In the present embodiment, an image is obtained from a link destination specified by a hyperlink embedded in a WEB page, and the image is displayed stereoscopically or planarly. However, it is considered that a page of an image, which has previously been registered by so-called bookmark function (“favorites” in the Internet Explorer), may be directly designated without an intervening WEB page. In this case, when the CPU 311 detects an operation of displaying a page of an image, which has previously been registered, by selecting a favorite, the CPU 311 obtains the image from the URL corresponding to the favorite, and then determines whether or not the image is a stereoscopically viewable image. When the result of determination is positive, the CPU 311 stereoscopically displays the image. In this case, the processes of steps S2 to S4, S14 to S18, and S191 are not necessary.

### [Function and Effect of the Present Embodiment]

As described above, according to the present embodiment, when a content obtained from the WEB server 100 is a stereoscopically viewable image, the content is displayed on the upper LCD 22 as a stereoscopically viewable image. Accordingly, when a stereoscopically viewable image is included in the content obtained from the WEB server 100, the stereoscopically viewable image can be appropriately stereoscopically displayed.

Further, in the present embodiment, instead of planarly displaying a content by the browser engine 322, the content is stereoscopically displayed by the image display processing program 323. Therefore, a stereoscopically viewable image, which should originally be planarly displayed like general contents, can be identified as a stereoscopically viewable image to be appropriately stereoscopically displayed.

Further, in the present embodiment, when the type of a content from a link destination is an image, it is determined whether or not the content is a stereoscopically viewable image. Therefore, it is possible to effectively avoid an unnecessary process of determining whether or not a content which is not an image is a stereoscopically viewable image.

Further, in the present embodiment, when the type of a content from a link destination is not an image, the content is planarly displayed. Therefore, it is possible to avoid an unnecessary process of determining whether or not a content which is not an image is a stereoscopically viewable image. As a result, an appropriate display process can be rapidly performed for the content which is not an image.

Further, in the present embodiment, it is determined whether or not a content obtained from a link destination is a stereoscopically viewable image, based on whether or not the content includes a plurality of images. Therefore, it is possible to easily determine whether or not the content obtained from the link destination is a stereoscopically viewable image. Further, the determination process can be performed more accurately as compared with the case where determination as to whether a content is a stereoscopically viewable image is performed based on the MIME type.

Further, in the present embodiment, when a content obtained from a link destination is a stereoscopically viewable image, the content is displayed on the upper LCD 22 which is different from the lower LCD 12 on which the contents other than the stereoscopically viewable image are displayed. Therefore, the user can easily recognize that the content obtained from the link destination is stereoscopically displayed on the screen as a stereoscopically viewable image.

### [Modifications]

The present invention is not limited to the embodiment described above. The present invention may be implemented in, for example, the following manners. That is, in the above-described embodiment, when it is determined that the type of a content obtained from a link destination is an image, a process of determining whether or not the content is a stereoscopically viewable image is performed. However, the content obtained from the link destination may be obtained without determining the type of the content, and then it is determined whether or not the obtained content is a stereoscopically viewable image.

Further, in the above-described embodiment, when a content obtained from a link destination is not a stereoscopically viewable image, the content is planarly displayed. However, when the content is not a stereoscopically viewable image, the content need not be displayed.

Further, in the above-described embodiment, a WEB page is planarly displayed on the lower LCD 12, and a content that cannot be stereoscopically displayed is displayed on the upper LCD 22 while a content that can be stereoscopically displayed is displayed on the upper LCD 22. However, the WEB page and the contents may be displayed on one screen. In this case, for example, a general WEB page is planarly displayed on the upper LCD 22, and the display of the WEB page is completed at a timing when a content as a stereoscopically viewable image is obtained from a link destination, and the obtained content is stereoscopically displayed on the upper LCD 22. Alternatively, the display of the WEB page is completed at a timing when a content that cannot be stereoscopically displayed is obtained from a link destination, and the obtained content is planarly displayed on the upper LCD 22.

Further, in the above-described embodiment, a series of process steps as described above is realized by using one game apparatus 10. However, the present invention is not limited thereto. The series of process steps as described above may be realized by a plurality of information processing apparatuses cooperating with each other. Specifically, the function of at least one of first obtaining means, first display control means, operation detection means, second obtaining means, first determination means, and second determination means may be realized by, for example, a server device on the network, different than the game apparatus 10. In this case, a system including the game apparatus 10 and the server device functions in the same manner as the game apparatus 10 described above.

Furthermore, in the above-described embodiment, the shape of the game apparatus 10, and the shapes, numbers, and mounting positions of the various operation buttons 14 and the touch panel 13 of the game apparatus 10 are only exemplary ones. Needless to say, the present invention may be realized by using other shapes, numbers, and mounting positions. Further, the order in which the process steps are performed, set values, threshold values used for the determinations, and the like, which are described above with reference to the flowcharts, are only exemplary ones. Needless to say, the present invention may be realized by using other order and values if the use of the order and values do not cause departure from the scope of the present invention.

Moreover, the display control program executed by the game apparatus 10 of the above-described embodiment may be supplied to the game apparatus 10 via a wired or wireless communication line as well as via a storage medium such as the external memory 44. Further, the display control program may be previously stored in a non-volatile storage device (the internal data storage memory 35 or the like) in the game apparatus 10. The information storage medium for storing the display control program may be, for example, a CD-ROM, a DVD, an optical disc-type storage medium similar to a CD-ROM or DVD, a flexible disk, a hard disk, a magneto-optical disk, and a magnetic tape, as well as a non-volatile memory. The information storage medium for storing the display control program may be a volatile memory for temporarily storing the display control program.

Moreover, in the above-described embodiment, the hand-held game apparatus 10 executes the display control program of the present invention to realize the present invention. However, a display control apparatus to which the present invention is applied may be a personal computer, or arbitrary hand-held electronic equipment such as a PDA (Personal Digital Assistant) or a mobile phone.

The present invention is applicable to, for example, a computer-readable storage medium having stored therein a display control program executed by a computer of a display control apparatus for displaying, on a screen, an image obtained from a server device such as a WEB server; a display control apparatus; a display control system; and a display control method.

While the invention has been described in detail, the foregoing description is in all aspects illustrative and not restrictive. It will be understood that numerous other modifications and variations can be devised without departing from the scope of the invention.

What is claimed is:

1. A computer-readable storage medium having stored therein a display control program executed by a computer of a display control apparatus for displaying, on a screen, an image obtained from a server device, wherein
the display control program causes the computer to function as:
first obtaining means for obtaining a first content from the server device;
first display control means for planarly displaying, on the screen, the first content obtained by the first obtaining means;
operation detection means for detecting an operation to display a second content different from the first content;
second obtaining means for obtaining the second content from the server device when an operation to display the second content is detected by the operation detection means;
first determination means for determining whether or not the second content obtained by the second obtaining means is a stereoscopically viewable image; and
second display control means for stereoscopically displaying, on the screen, the stereoscopically viewable image as the second content, when the result of the determination by the first determination means is positive.

2. The computer-readable storage medium having stored therein the display control program according to claim 1, wherein
the second display control means planarly displays the second content on the screen when the result of the determination by the first determination means is negative.

3. The computer-readable storage medium having stored therein the display control program according to claim 1, wherein
the second display control means stereoscopically display the second content, instead of the process of planarly displaying the second content by the first display control means.

4. The computer-readable storage medium having stored therein the display control program according to claim 1, wherein
the display control program causes the computer to further function as:
third obtaining means for obtaining the type of the second content when an operation to display the second content is detected by the operation detection means; and
second determination means for determining whether or not the type obtained by the third obtaining means is an image, and wherein
the first determination means determines whether or not the second content is a stereoscopically viewable image when the result of the determination by the second determination means is positive.

5. The computer-readable storage medium having stored therein the display control program according to claim 4, wherein
the first display control means planarly displays the second content obtained by the second obtaining means, when the result of the determination by the second determination means is negative.

6. The computer-readable storage medium having stored therein the display control program according to claim 1, wherein
the first determination means determines whether or not the second content is a stereoscopically viewable image, based on whether or not the second content obtained by the second obtaining means includes a plurality of images.

7. The computer-readable storage medium having stored therein the display control program according to claim 1, wherein
the screen includes a first screen capable of planarly viewable display and a second screen capable of stereoscopically viewable display,
the first display control means performs planarly viewable display by using the first screen, and
the second display control means performs stereoscopically viewable display by using the second screen.

8. The computer-readable storage medium having stored therein the display control program according to claim 1, wherein
the display control program causes the computer to further function as:
storage control means for storing, in storage means, at least the stereoscopically viewable image stereoscopically displayed by the second display control means, in accordance with a user's input.

9. The computer-readable storage medium having stored therein the display control program according to claim 1, wherein
the second display control means displays the second content in an area on the screen, which is different from an area on the screen where the first content is displayed by the first display control means.

10. The computer-readable storage medium having stored therein the display control program according to claim 1, wherein
the operation detection means detects an operation to display the second content, when the first content is planarly displayed by the first display control means.

11. The computer-readable storage medium having stored therein the display control program according to claim 1, wherein
the first content and the second content are contents of a WEB page,
a hyperlink linked to the second content is embedded in the first content,
the operation detection means detects an operation to specify the hyperlink, and
when the result of the determination by the first determination means is positive, the second display control means stereoscopically displays the stereoscopically viewable image as the second content, instead of that the first display control means planarly displays the content of the WEB page as the second content.

12. A computer-readable storage medium having stored therein a display control program executed by a computer of a display control apparatus for displaying, on a screen, an image obtained from a server device, wherein
the display control program causes the computer to function as:
operation detection means for detecting an operation to display a content;
obtaining means for obtaining, when an operation to display a content is detected by the operation detection means, the content from the server device;
determination means for determining whether or not the content obtained by the obtaining means is a stereoscopically viewable image; and
display control means for stereoscopically displaying, on the screen, the stereoscopically viewable image as the content, when the result of the determination by the determination means is positive.

13. A display control apparatus for displaying, on a screen, an image obtained from a server device, the display control apparatus comprising:
first obtaining means for obtaining a first content from the server device;
first display control means for planarly displaying, on the screen, the first content obtained by the first obtaining means;
operation detection means for detecting an operation to display a second content different from the first content;
second obtaining means for obtaining the second content from the server device when an operation to display the second content is detected by the operation detection means;
first determination means for determining whether or not the second content obtained by the second obtaining means is a stereoscopically viewable image; and
second display control means for stereoscopically displaying, on the screen, the stereoscopically viewable image as the second content, when the result of the determination by the first determination means is positive.

14. A display control system for displaying, on a screen, an image obtained from a server device, the display control system comprising:
first obtaining means for obtaining a first content from the server device;
first display control means for planarly displaying, on the screen, the first content obtained by the first obtaining means;
operation detection means for detecting an operation to display a second content different from the first content;
second obtaining means for obtaining the second content from the server device when an operation to display the second content is detected by the operation detection means;
first determination means for determining whether or not the second content obtained by the second obtaining means is a stereoscopically viewable image; and
second display control means for stereoscopically displaying, on the screen, the stereoscopically viewable image as the second content, when the result of the determination by the first determination means is positive.

15. A display control method for displaying, on a screen, an image obtained from a server device, the display control method comprising the steps of:
obtaining a first content from the server device;
planarly displaying, on the screen, the obtained first content;
detecting an operation to display a second content different from the first content;
obtaining the second content from the server device when an operation to display the second content is detected;
determining whether or not the obtained second content is a stereoscopically viewable image; and
stereoscopically displaying, on the screen, the stereoscopically viewable image as the second content, when it is determined that the second content is a stereoscopically viewable image.
